(19) United States
(12) Patent Application Publication
(10) Pub. No.: US 2016/0314523 A1
(43) Pub. Date: Oct. 27, 2016

(54) PRESENTATION OF BIDDING ACTIVITY

(71) Applicant: eBay Inc., San Jose, CA (US)

(72) Inventors: Kiran Kanchamreddy, San Jose, CA (US); Teil Wise, Campbell, CA (US); David Green, San Jose, CA (US); Harita Yenisetty, Sunnyvale, CA (US); Bhavani Kumar Hari, Campbell, CA (US); Alejandro Araujo, San Jose, CA (US); Gayathri Ravichandran Geetha, Sunnyvale, CA (US)

(21) Appl. No.: 14/693,684

(22) Filed: Apr. 22, 2015

(51) Int. Cl. G06Q 30/08; G06F 3/0484; G06Q 30/06

(52) U.S. Cl. CPC G06Q 30/08; G06Q 30/0641; G06F 3/04842

(57) ABSTRACT

In various example embodiments, a system and method for presentation of bidding activity are presented. A series of bids is received from users participating in an auction of an item that is available for sale from an online marketplace. One or more values from the series of bids are determined. Times of receipt for the series of bids are also determined. A graph that depicts the series of bids as a set of points is generated. Display of the graph on a web page corresponding to the auction of the item is caused.

### TECHNICAL FIELD

Embodiments of the present disclosure relate generally to data processing and, more particularly, but not by way of limitation, to presentation of bidding activity.

### BACKGROUND

Conventionally a user may participate in an online auction. Moreover, the online auction may indicate to the user an amount of time remaining in the online auction. Further, the user may place a bid on an item in the online auction.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 is a flow diagram illustrating components of a graph system, according to some example embodiments.

FIG. 3-6 are flowcharts illustrating operations of the graph system in performing a method of causing display of a graph on a web page corresponding to an auction, according to some example embodiments.

FIGS. 7-9 are example user interfaces illustrating graphs that depict a series of bids, according to some example embodiments.

FIG. 10 is a block diagram illustrating an example of a software architecture that may be installed on a machine, according to some example embodiments.

FIG. 11 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In various example embodiments a user may participate in an online auction of an item that is displayed on a web page. A system may assist the user by providing a graph that shows user activity with regards to the online auction of the item. More specifically, the graph depicts bids that are received during the course of the auction. The graph also shows when the bids are received and their corresponding values. In this regard, the user is able to conveniently view all of the bidding activity in the online auction. As more bids are received, the system may update the graph to reflect bidding activity for all the received bids. In some instances, the graph is selectable to receive user inputs that affect the series of bids. For example, the user is able to interact with the graph to place a bid for the item being auctioned. For instance, the user may click on point on the graph and subsequently have a bid that corresponds to the clicked point be placed in the auction.

Moreover, the graph may include various metrics regarding the auction that may be helpful to the user. For example, the graph could indicate if a specific competing user has placed one or more bids during the auction and which bids were submitted by that competing user.

Accordingly, one or more of the methodologies discussed herein may obviate a need for the user to manually browse through auction data to determine bidding activity for an online auction, which may have the technical effect of reducing computing resources used by one or more devices within the system. Examples of such computing resources include, without limitation, processor cycles, network traffic, memory usage, storage space, and power consumption. Additionally, the one or more of the methodologies discussed herein may facilitate the user's interaction with the series of bids by providing the displayed graph.

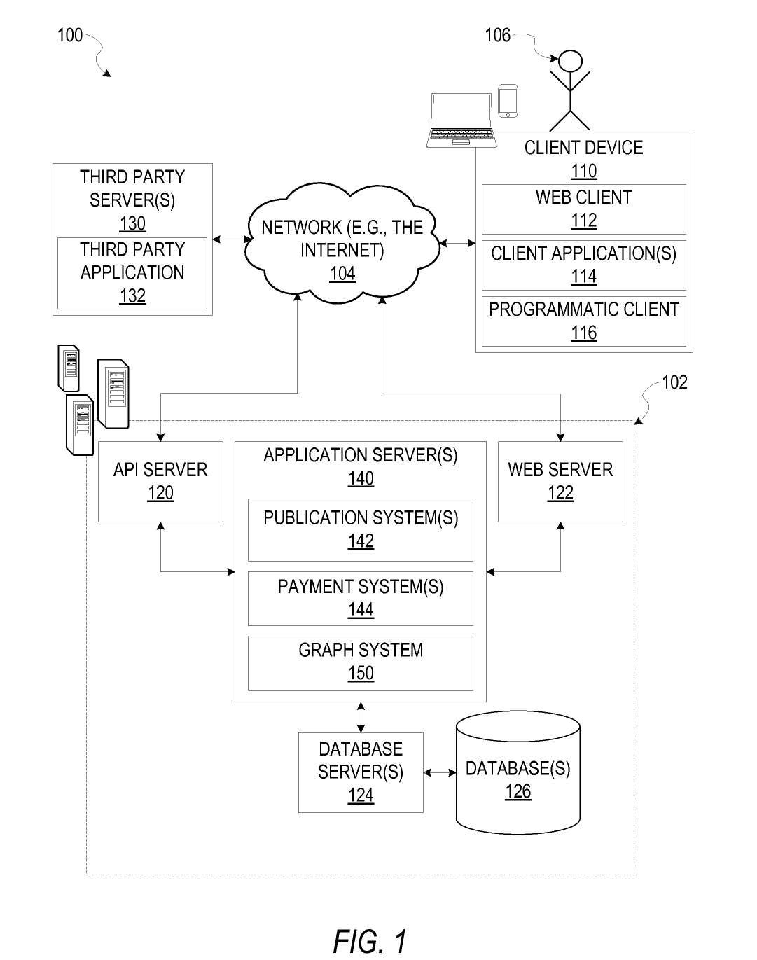

With reference to FIG. 1, an example embodiment of a high-level client-server-based network architecture 100 is shown. A networked system 102, in the example forms of a network-based marketplace or payment system, provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Wash. State), an application 114, and a programmatic client 116 executing on client device 110.

The client device 110 may comprise, but are not limited to, a mobile phone, desktop computer, laptop, portable digital assistants (PDAs), smart phones, tablets, netbooks, laptops, multi-processor systems, microprocessor-based or programmable consumer electronics, or any other communication device that a user may utilize to access the networked system 102. In some embodiments, the client device 110 may comprise a display module (not shown) to display information (e.g., in the form of user interfaces). In further embodiments, the client device 110 may comprise one or more of a touch screens, accelerometers, gyroscopes, cameras, microphones, global positioning system (GPS) devices, and so forth. The client device 110 may be a device of a user that is used to perform a transaction involving digital items within the networked system 102. In one embodiment, the networked system 102 is a network-based marketplace that responds to requests for product listings, publishes publications comprising item listings of products available on the network-based marketplace, and manages payments for these marketplace transactions. One or more users 106 may be a person, a machine, or other means of interacting with client device 110. In embodiments, the user 106 is not part of the network architecture 100, but may interact with the network architecture 100 via client device 110 or another means. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the client device 110 may include one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given one of the client device 110, then this application is configured to locally provide the user interface and at least some of the functionalities with the application configured to communicate with the networked system 102, on an as needed basis, for data and/or processing capabilities not locally available (e.g., access to a database of items available for sale, to authenticate a user, to verify a method of payment, etc.). Conversely if the e-commerce site application is not included in the client device 110, the client device 110 may use its web browser to access the e-commerce site (or a variant thereof) hosted on the networked system 102.

One or more users 106 may be a person, a machine, or other means of interacting with the client device 110. In example embodiments, the user 106 is not part of the network architecture 100, but may interact with the network architecture 100 via the client device 110 or other means. For instance, the user provides input (e.g., touch screen input or alphanumeric input) to the client device 110 and the input is communicated to the networked system 102 via the network 104. In this instance, the networked system 102, in response to receiving the input from the user, communicates information to the client device 110 via the network 104 to be presented to the user. In this way, the user can interact with the networked system 102 using the client device 110.

An application program interface (API) server 120 and a web server 122 are coupled to, and provide programmatic and web interfaces respectively to, one or more application servers 140. The application servers 140 may host one or more publication systems 142 and payment systems 144, each of which may comprise one or more modules or applications and each of which may be embodied as hardware, software, firmware, or any combination thereof. The application servers 140 are, in turn, shown to be coupled to one or more database servers 124 that facilitate access to one or more information storage repositories or database(s) 126. In an example embodiment, the databases 126 are storage devices that store information to be posted (e.g., publications or listings) to the publication system 142. The databases 126 may also store digital item information in accordance with example embodiments.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, marketplace, or payment functions that are supported by the relevant applications of the networked system 102.

The publication systems 142 may provide a number of publication functions and services to users 106 that access the networked system 102. The payment systems 144 may likewise provide a number of functions to perform or facilitate payments and transactions. While the publication system 142 and payment system 144 are shown in FIG. 1 to both form part of the networked system 102, it will be appreciated that, in alternative embodiments, each system 142 and 144 may form part of a payment service that is separate and distinct from the networked system 102. In some embodiments, the payment systems 144 may form part of the publication system 142.

The graph system 150 may provide functionality operable to cause display of a graph that depicts bidding activity for an item of an item. In generating the graph, the graph system 150 may access the auction data (e.g., bidding activity) from the databases 126, the third party servers 130, the publication system 142, and other sources. Alternatively, the graph system 150 may also receive auction data from the client device 110 of a user participating in the auction. In some example embodiments, the graph system 150 analyzes the auction data and creates a visual representation of the auction data to be displayed as a graph on a web page corresponding to the auction. In some example embodiments, the graph system 150 communicates with the publication systems 142 (e.g., accessing item listings) and payment system 144. In an alternative embodiment, the graph system 150 may be a part of the publication system 142.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The various publication system 142, payment system 144, and graph system 150 could also be implemented as standalone software programs, which do not necessarily have networking capabilities.

The web client 112 may access the various publication and payment systems 142 and 144 via the web interface supported by the web server 122. Similarly, the programmatic client 116 accesses the various services and functions provided by the publication and payment systems 142 and 144 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

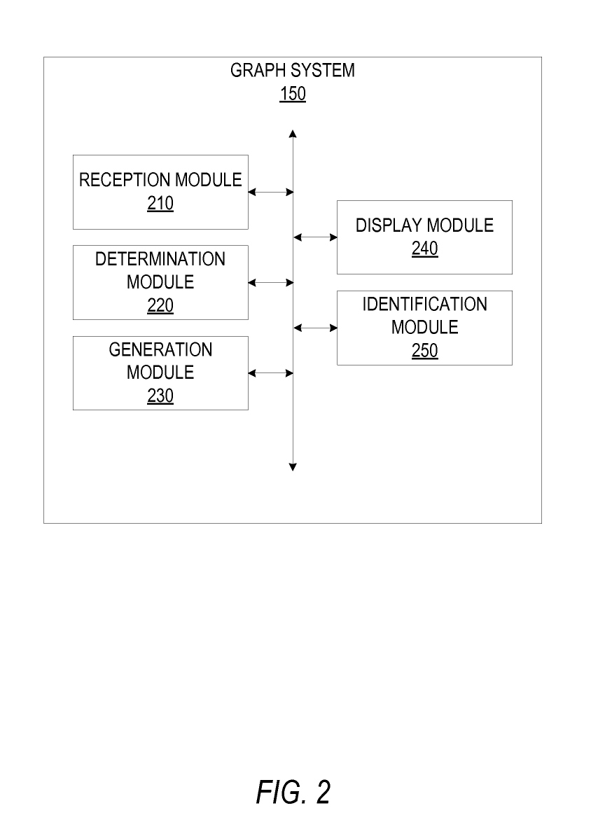

FIG. 2 is a block diagram illustrating components of the graph system 150, according to some example embodiments. The graph system 150 is shown as including a reception module 210, a determination module 220, a generation module 230, a display module 240, and an identification module 250, all configured to communicate with each other (e.g., via a bus, shared memory, or a switch). Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

In various example embodiments, the reception module 210 is configured to receive a series of bids from users participating in an auction of an item. The item may be available for sale from an online marketplace (e.g., network-based marketplace). Moreover, each of the bids from the series of bids may indicate a value that a respective user willing to pay for the item being auctioned. To receive the bids from the users, in various example embodiments, the reception module 210 is configured to receive inputs from one or more client devices (e.g., client device 110).

In various example embodiments, the determination module 220 is configured to determine one or more values from the series of bids received by the reception module 210. The determination module 220 is further to determine times of receipt for the series of bids received by the reception module 210. In further embodiments, the determination module 220 is to determine a value associated with the input from the client device, as further explained below. In additional embodiments, the determination module 220 is further to compare the value associated with the input with the one or more values from the series of bids. In other words, the determination module 220 is further to determine that the value associated with the input is greater than the one or more values from the series of bids.

In some instances, the determination module 220 is further to determine that a last bid in the series of bids is received. The graph system 150 may use this determination to close the auction. In some embodiments, once the auction has been closed, no further bids will be received from the auction participants. Moreover, the reception module 210 is further to discard any bids that are received after the determination to close the auction. In further embodiments, the determination module 220 is to determine a length of time during which at least a predetermined number of bids from the series of bids are received. The determination module 220 is further to calculate a value based on the predetermined number of bids that are received during the determined length of time.

In various example embodiments, the generation module 230 is configured to generate a graph that depicts the series of bids as a set of points based on the determined one or more values and the determined times of receipt. The graph may further include various metrics regarding the series of bids, and the generation module 230 is further to generate these metrics as part of the graph. Moreover, the generation module 230 may update the graph to depict further bids in addition to the already depicted series of bids. In various example embodiments, the generation module 230 is further to generate a bid based on the value associated with the input.

In various example embodiments, the display module 240 is configured to cause display of a web page corresponding to the auction of the item. Moreover, the display module 240 is further configured to cause display of the graph on the web page corresponding to the auction of the item. In various example embodiments, the graph is selectable to receive user inputs that affect the series of bids, as further explained below.

In various example embodiments, the identification module 250 is configured to identify at least one bid from the series of bids that is received from a particular user. In doing so, the identification module 250 is further to identify the particular user based on user selection. For instance, the reception module 210 may receive a user selection which indicates the particular user. Alternatively, the identification module 250 identifies the particular user based on the activity of the particular user. For instance, the identification module 250 may detect that the particular user submitted at least a predetermined threshold number of bids in the auction.

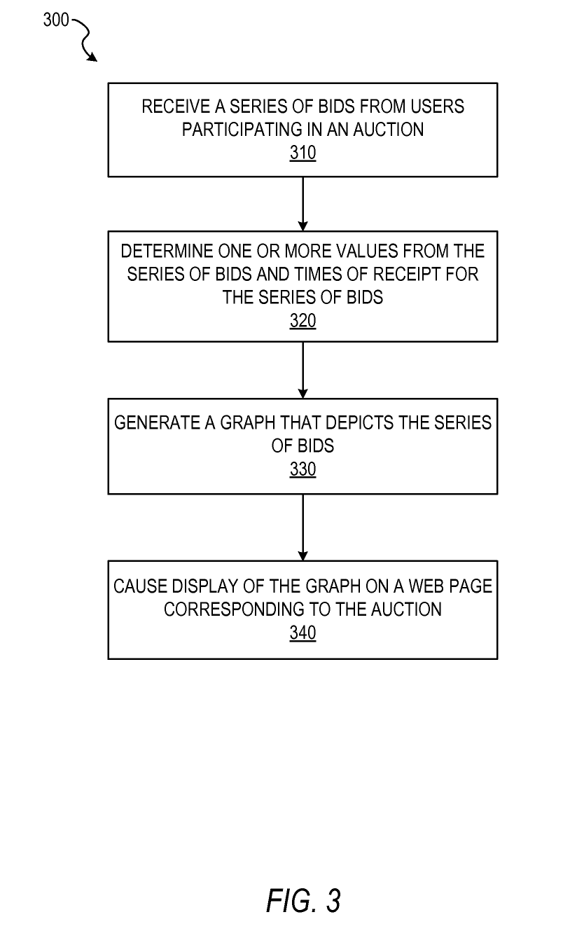

FIG. 3-6 are flowcharts illustrating operations of the graph system 150 in performing a method 300 of causing display of a graph on a web page corresponding to an auction, according to some example embodiments. Operations in the method 300 may be performed by the graph system 150, using modules described above with respect to FIG. 2. As shown in FIG. 3, the method 300 includes operations 310, 320, 330, and 340.

At operation 310, the reception module 210 receives a series of bids from users participating in an auction of an item that is available for sale from an online marketplace (e.g., network-based marketplace). In some instances, the auction is conducted and displayed on a web page that corresponds to the auction of the item. The web page that corresponds to the auction of the item may include a description of the item and an image of the item. Further, the web page that corresponds to the auction of the item may be viewed by the users participating in the auction of the item from their respective client devices. Additionally, the users may use their respective client devices to place their bids on the item being auctioned. As such, the reception module 210 is further to receive the series of bids from the client devices of the users participating in the auction.

In various example embodiments, the bids from the series of bids are received by the reception module 210 at different times during the auction. For example, the series of bids may include a first bid and a second bid. Further, a first user may place the first bid for the item five seconds into the auction. Subsequently, a second user may place the second bid for the item twelve seconds into the auction. In further embodiments, duration of the auction is not a fixed length of time. Therefore, the auction can continue until a final bid as been received, as further explained below.

At operation 320, the determination module 220 determines one or more values from the series of bids. As stated earlier, each bid indicates a value that a respective user is willing to pay for the item being auctioned. Therefore, the determination module 220 may parse through the series of bids received at the reception module 210 in order to determine the one or more values from the series of bids. Also, since the bids from the series of bids are received at different times during the auction, the determination module 220 is further to identify when each bid from the series of bids is received at the reception module 210. In other words, the determination module 220 identifies times of receipt for the series of bids.

At operation 330, the generation module 230 generates a graph that depicts the series of bids as a set of points based on the determined one or more values from the series of bids and based on the determined times of receipt for the series of bids. In some instances, the graph is a two-dimensional graph including a first axis and a second axis. The first axis represents value and therefore may correspond to the one or more values from the series of bids. The second axis represents time and therefore may correspond to the times of receipt for the series of bids. As such, the generation module 230 is further to position the set of points on the graph according to the one or more values and the times of receipt determined at operation 320. In other words, each of the points may be positioned on the graph at a location that corresponds to its respective value and that corresponds to its respective time of receipt. In some instances, the generation module 230 is further to depict the series of bids as increasing in value over time by a predetermined increment. This may be due to the fact that the bidding for the item occurs in increments and therefore each subsequent bid in the series of bids increases in value by the predetermined increment. For example, bidding for an item may occur in five dollar increments. As a result, the graph depicts the series of bids as increasing in five dollar increments.

At operation 340, the display module 240 causes display of the graph on the web page that corresponds to the auction of the item. The graph may be displayed in order to provide a visualization of the bidding activity of the users participating in the auction. Moreover, the web page that corresponds to the auction of the item may be viewed on a client device of a user. In various example embodiments, the auction may include a collection of items. Therefore, the display module 240 is further to cause display of a graph for each item in the collection of items.

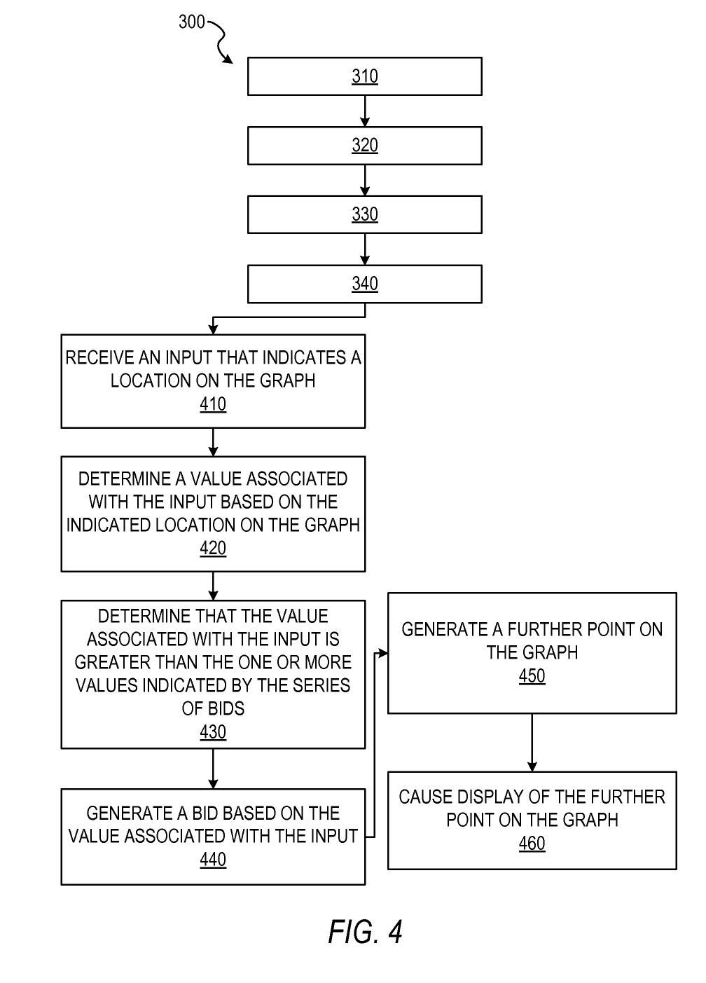

As shown in FIG. 4, the method 300 includes operations 410, 420, 430, 440, 450, and 460. Further, the operations 410, 420, 430, and 440 may be performed after operation 340. Moreover, the operations 450, and 460 each may be performed as part of the operation 340.

At operation 410, the reception module 210 receives an input that indicates a location on the graph displayed on the web page that corresponds to the auction of the item. A user operating the client device may wish to submit a bid in addition to the series of bids that have already been received at operation 310. In doing so, the user may interact with the graph displayed on the web page that corresponds to the auction of the item to submit the bid. More specifically, the user operating the client device sends an input to the reception module 410. The input indicates the location on the graph. In some instances, the input corresponds to a mouse-click over the location on the graph. In alternative embodiments, the input is information that describes the location on the graph. In further embodiments, the graph includes a sliding bar and the input is movement of the sliding bar to the location on the graph.

At operation 420, the determination module 220 determines a value associated with the input based on the indicated location on the graph. In other words, since the graph includes the first axis which represents value, the location on the graph may be associated with a corresponding value. The determination module 220 may use the location on the graph to determine the value associated with the input. For example, the location on the graph may be located at a position on the graph that has a corresponding value of 20 dollars.

At operation 430, the determination module 220 determines that the value associated with the input is greater than the one or more values from the series of bids. This ensures that the value associated with the input complies with the auction format given that the one or more values from the series of bids have already been submitted. Subsequently, the value associated with the input is generated as a bid at operation 440.

At operation 440, the generation module 230 generates a bid based on the value associated with the input. The generated bid indicates the value associated with the input. In some instances, the generation module 230 is further to place the generated bid as part of the auction. For instance, the generation module 230 sends the bid information to a server that manages or runs the online auction.

At operation 450, the generation module 230 generates a further point on the graph based on the value associated with the input. The further point may be used to represent the bid that is generated at operation 440.

At operation 460, the display module 240 causes display of the further point on the graph. In some instances, the display module 240 refreshes the graph by including the generated further point inside the graph. Moreover, the further point may be positioned at a location on the graph that corresponds to the value associated with the input. In some embodiments, the further point may a positioned at the same location as the location on the graph indicated by the input. In alternate embodiments, the further point may be positioned at a location near the location on the graph indicated by the input.

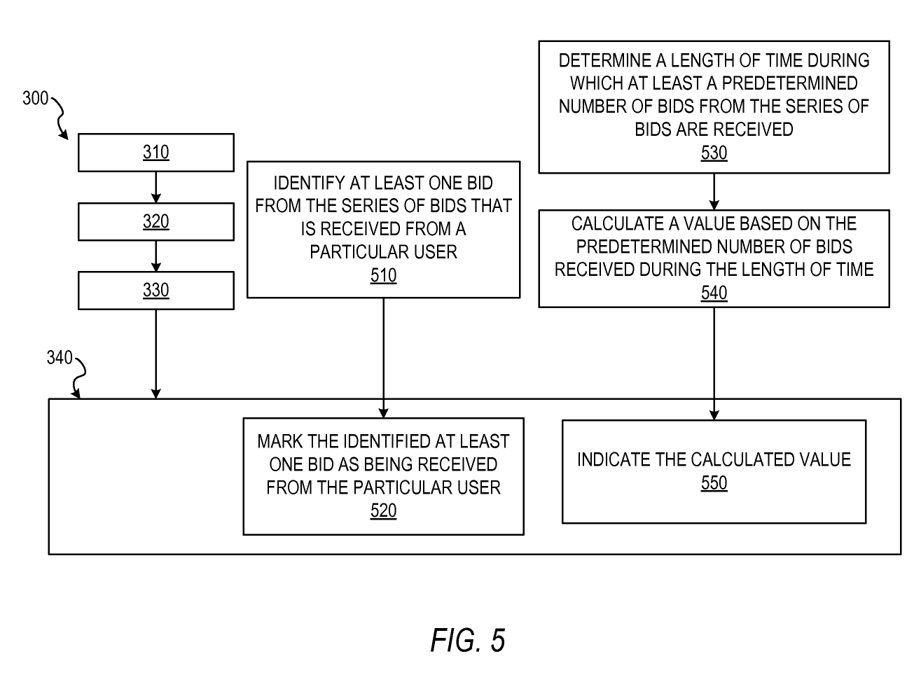

As shown in FIG. 5, the method 300 includes operations 510, 520, 530, 540, and 550. The operations 520 and 550 may each be included as part of operation 340. Moreover, the operations 510, 530, and 540 are performed prior to the operation 340.

At operation 510, the identification module 250 identifies at least one bid from the series of bids that is received from a particular user. For instance, the particular user may have submitted more than one bid in the series of bids. As part of the operation 510, the identification module 250 may identify the particular user based on the activity of the particular user in the auction. For instance, the identification module 250 may detect that the particular user submitted at least a predetermined threshold number of bids in the auction. In alternate embodiments, the identification module 250 identifies the at least one bid that is received from the particular user based on a user selection from the graph. For example, a further user may click on one of the bids depicted on the graph that were submitted by the particular user. As a result of the selection from the graph, the identification module 250 identifies all bids from that particular user.

At operation 520, the generation module 230 marks the identified at least one bid as being received from the particular user. The marks may include bolding the at least one bid, coloring the at least one bid, annotating the at least one bid, placing a box around the bid, and the like. Further, the operation 420 may be performed as part of the operation 330 of FIG. 3. In other words, the marking the identified at least one bid as being received from the particular user is performed as part of the generation of the graph at operation 330. In this regard, the graph is marked to show the at least one bids being received from the particular user. This may be useful to help visualize the bidding activity of that particular user, especially if the user has submitted several bids during the bidding process.

At operation 530, the determination module 220 determines a length of time during which at least a predetermined number of bids from the series of bids are received. In other words, the determination module 220 identifies when the users participating in the auction are most actively bidding on the item. For example, bidding for the item might escalate during the middle of the auction when the price is more desirable or affordable to a majority of the users. However after that period of time has elapsed, the price may no longer be favorable to the majority of the users, leaving only a few remaining users placing their bids on the item.

At operation 540, the determination module 220 calculates a value based on the predetermined number of bids received during the length of time. The determination module 220 may calculate the average bid price of the predetermined number of bids received during the length of time. Alternatively, in some embodiments, the determination module 220 calculates the median bid price of the predetermined number of bids received during the length of time. The calculated value may represent a price that most desirable or affordable to the majority of the users participating in the auction.

At operation 550, the generation module 230 indicates the calculated value. For example, the generation module may display the calculated value beneath the graph. The operation 450 may be performed as part of the operation 330 in FIG. 3. In this regard, the graph is marked to show the calculated value. The indication of the calculated value may appear as a point on the depicted graph. For example, the calculated value may appear as a horizontal line across the graph.

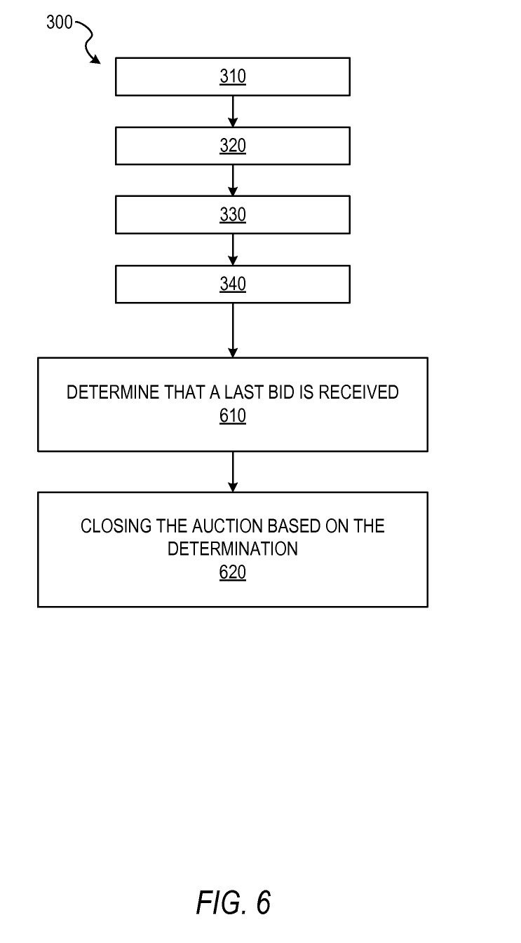

As shown in FIG. 6, the method 300 includes operations 610 and 620. The operations 610 and 620 may be performed after the operation 340.

At operation 610, the determination module 220 determines that a last bid is received. In doing so, the determination module 220 may determine that no further bids are received for a predetermined period of time after the receiving of the last bid. For example, the determination module 220 determines that no further bids are received for 10 seconds after the receiving of the last bid.

At operation 620, the determination module 220 closes the auction of the item based on the determination. Once the auction has been closed, no further bids may be received from the auction participants. Moreover, the generated graph will remain static because all of the bids have been received and represented as a point on the graph.

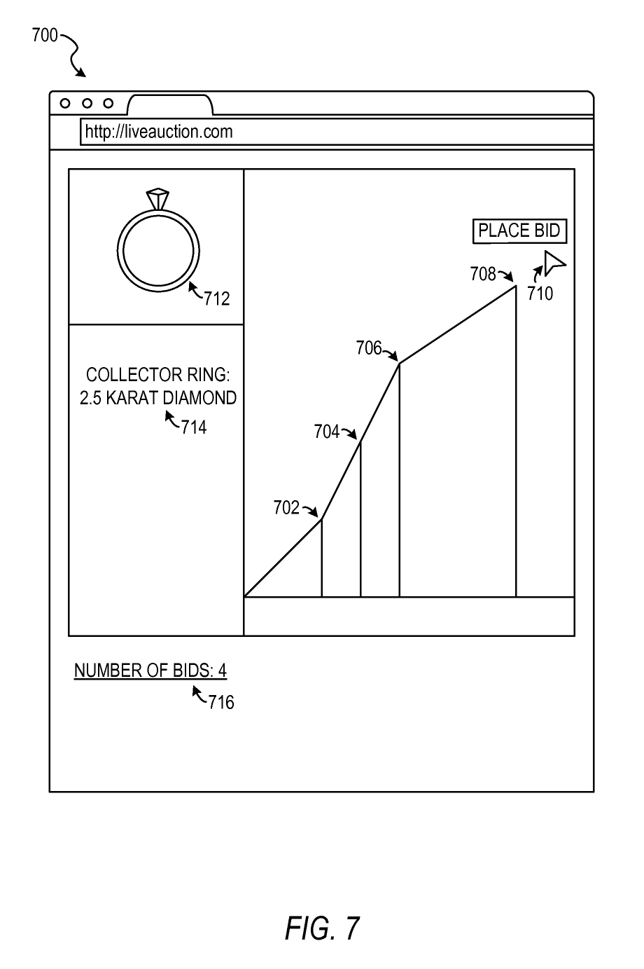

FIG. 7 is an example user interface 700 illustrating a graph that depicts a series of bids, according to some example embodiments. The user interface 700 may be displayed on a client device. The graph includes a first point 702, a second point 704, a third point 706, and a fourth point 708. Each of the points represents a bid that is submitted during the auction of an item. Moreover a description of the item 714 and a picture of the item 712 are shown in the user interface 700. Also, a user, by indicating a location on the graph, is able to submit a bid. The user may perform this indication by clicking on the location. As shown in FIG. 7, the user interface 700 includes a cursor 710 that the user may operate in order to indicate the location. The user interface 700 further includes information 716 about the graph, such as showing the number of bids that have already been submitted during the auction. In alternate embodiments, the graph is a touch-sensitive and the user may place a finger on the graph in order to indicate the location.

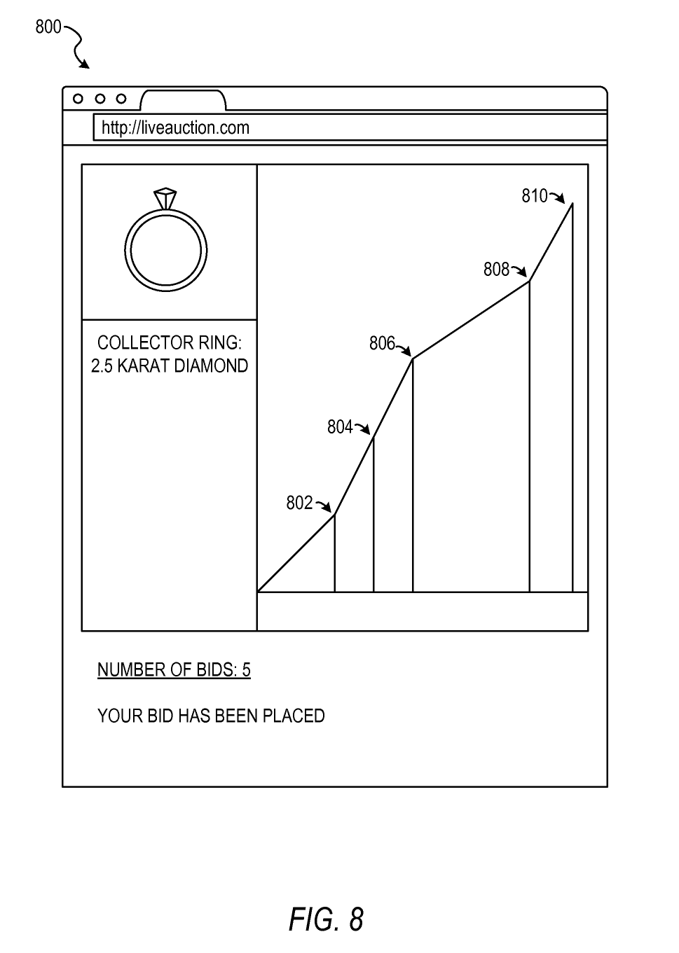

FIG. 8 is an example user interface 800 illustrating a graph that depicts a series of bids, according to some example embodiments. The user interface 800 may be displayed on a client device. As shown in FIG. 8, the user interface 800 includes a graph that depicts a series of bids. Also, FIG. 8 may be shown on the client device after the user submits a bid using the cursor 710 shown in FIG. 7. The graph includes a first point 802, a second point 804, a third point 806, a fourth point 808, and a fifth point 810. Each of the points represents a bid that is submitted during the auction of an item. Moreover, the fifth point 810 may correspond to the bid that was submitted using the cursor 710 in FIG. 8.

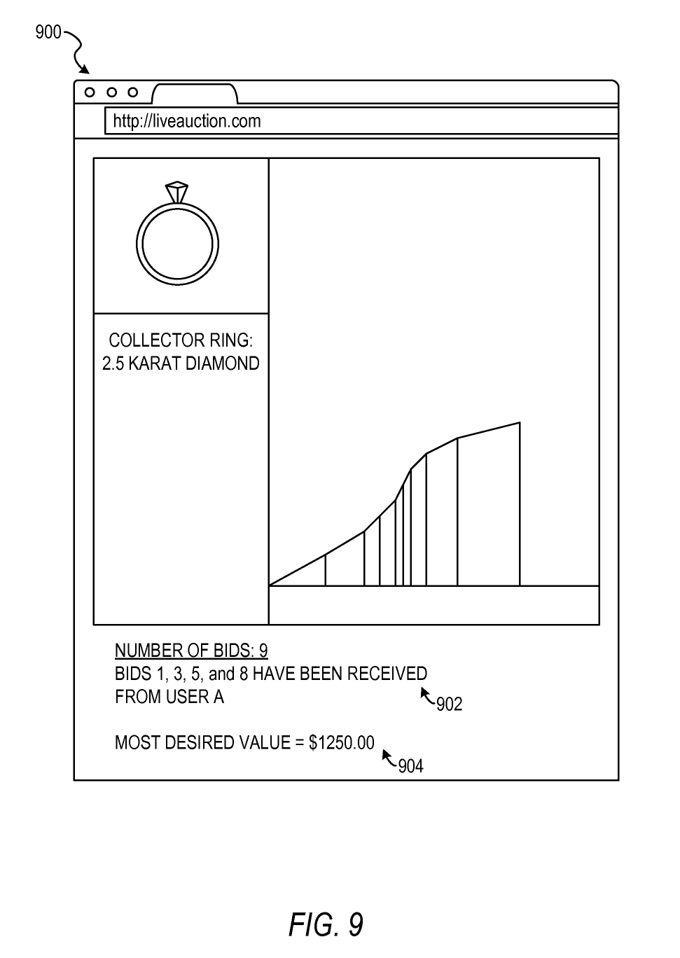

FIG. 9 is an example user interface 900 illustrating a graph that depicts a series of bids, according to some example embodiments. The user interface 900 may be displayed on a client device. The user interface 900 includes a first metric 902 to indicate which bids have been received from a particular user. Although not shown, the bids received from the particular user may also be highlighted or marked. The user interface 900 also includes a second metric 904 to indicate a calculated value. The value may have been calculated during a period of time when a large number of bids are being submitted by the users of the online auction, corresponding to operations 530, and 540 of FIG. 5.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

The modules, methods, applications and so forth described in conjunction with FIGS. 2-6 are implemented in some embodiments in the context of a machine and associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

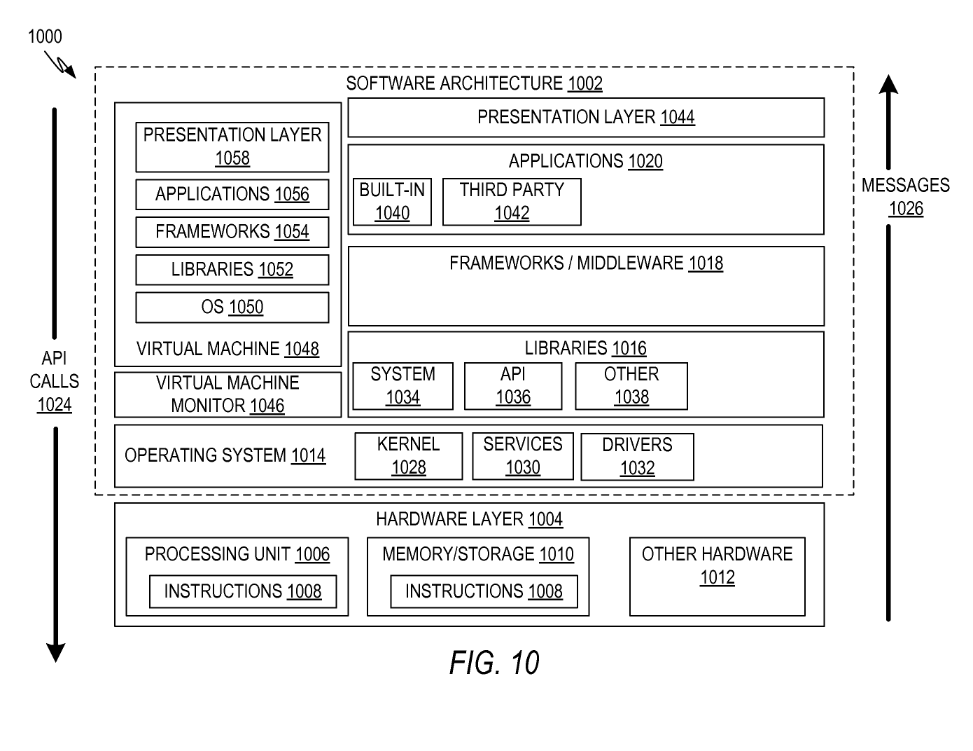

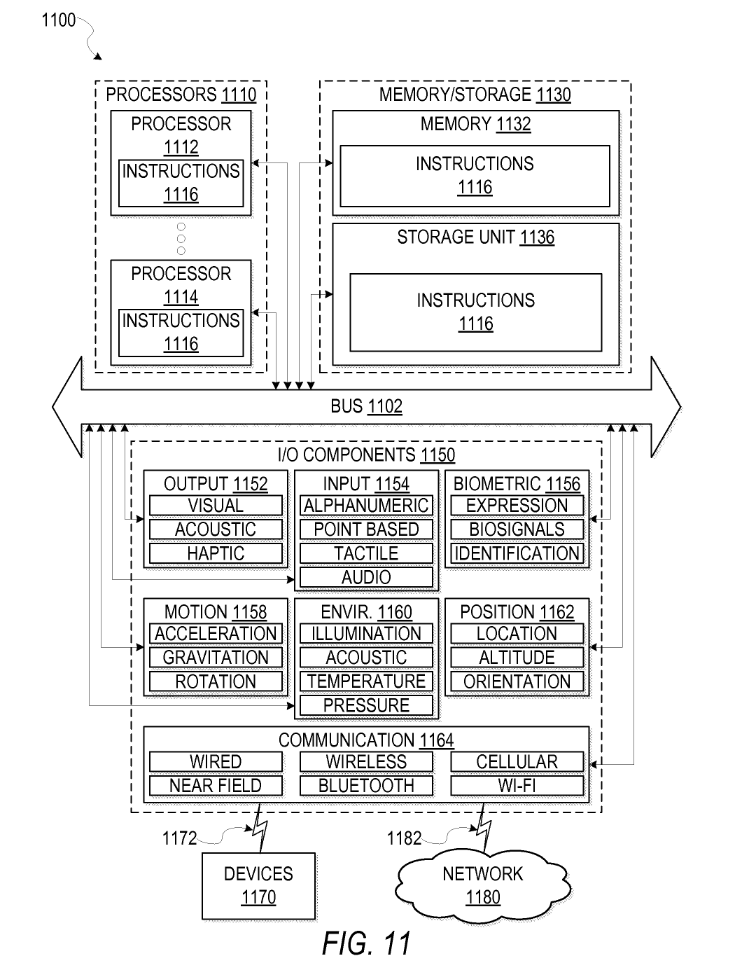

FIG. 10 is a block diagram 1000 illustrating a representative software architecture 1002, which may be used in conjunction with various hardware architectures herein described. FIG. 10 is merely a non-limiting example of a software architecture and it will be appreciated that many other architectures may be implemented to facilitate the functionality described herein. The software architecture 1002 may be executing on hardware such as machine 1100 of FIG. 11 that includes, among other things, processors 1110, memory 1130, and I/O components 1150. A representative hardware layer 1004 is illustrated and can represent, for example, the machine 1100 of FIG. 11. The representative hardware layer 1004 comprises one or more processing units 1006 having associated executable instructions 1008. Executable instructions 1008 represent the executable instructions of the software architecture 1002, including implementation of the methods, modules and so forth of FIGS. 2-6. Hardware layer 1004 also includes memory and/or storage modules 1010, which also have executable instructions 1008. Hardware layer 1004 may also comprise other hardware as indicated by 1012 which represents any other hardware of the hardware layer 1004, such as the other hardware illustrated as part of machine 1100.

In the example architecture of FIG. 10, the software 1002 may be conceptualized as a stack of layers where each layer provides particular functionality. For example, the software 1002 may include layers such as an operating system 1014, libraries 1016, frameworks/middleware 1018, applications 1020 and presentation layer 1044. Operationally, the applications 1020 and/or other components within the layers may invoke application programming interface (API) calls 1024 through the software stack and receive a response, returned values, and so forth illustrated as messages 1026 in response to the API calls 1024. The layers illustrated are representative in nature and not all software architectures have all layers. For example, some mobile or special purpose operating systems may not provide a frameworks/middleware layer 1018, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software modules to perform tasks in an easier fashion than to interface directly with the underlying operating system 1014 functionality (e.g., kernel 1028, services 1030 and/or drivers 1032). The libraries 1016 may include system 1034 libraries (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks 1018 (also sometimes referred to as middleware) may provide a higher-level common infrastructure that may be utilized by the applications 1020 and/or other software components/modules. For example, the frameworks 1018 may provide various graphic user interface (GUI) functions, high-level resource management, high-level location services, and so forth. The frameworks 1018 may provide a broad spectrum of other APIs that may be utilized by the applications 1020 and/or other software components/modules, some of which may be specific to a particular operating system or platform.

The applications 1020 include built-in applications 1040 and/or third party applications 1042. Examples of representative built-in applications 1040 may include, but are not limited to, a contacts application, a browser application, a book reader application, a location application, a media application, a messaging application, and/or a game application. Third party applications 1042 may include any of the built in applications as well as a broad assortment of other applications. In a specific example, the third party application 1042 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 1042 may invoke the API calls 1024 provided by the mobile operating system such as operating system 1014 to facilitate functionality described herein.

The applications 1020 may utilize built in operating system functions (e.g., kernel 1028, services 1030 and/or drivers 1032), libraries (e.g., system 1034, APIs 1036, and other libraries 1038), frameworks/middleware 1018 to create user interfaces to interact with users of the system. Alternatively, or additionally, in some systems interactions with a user may occur through a presentation layer, such as presentation layer 1044. In these systems, the application/module “logic” can be separated from the aspects of the application/module that interact with a user.

Some software architectures utilize virtual machines. In the example of FIG. 10, this is illustrated by virtual machine 1048. A virtual machine creates a software environment where applications/modules can execute as if they were executing on a hardware machine (such as the machine of FIG. 11, for example). A virtual machine is hosted by a host operating system and typically, although not always, has a virtual machine monitor 1046, which manages the operation of the virtual machine as well as the interface with the host operating system (i.e., operating system 1014). A software architecture executes within the virtual machine such as an operating system 1050, libraries 1052, frameworks/middleware 1054, applications 1056 and/or presentation layer 1058. These layers of software architecture executing within the virtual machine 1048 can be the same as corresponding layers previously described or may be different.

FIG. 11 is a block diagram illustrating components of a machine 1100, according to some example embodiments, able to read instructions from a machine-readable medium (e.g., a machine-readable storage medium) and perform any one or more of the methodologies discussed herein. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein may be executed. For example the instructions may cause the machine to execute the flow diagrams of FIGS. 3-6. Additionally, or alternatively, the instructions may implement as described and shown in FIG. 2, and so forth. The instructions transform the general, non-programmed machine into a particular machine programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1116, sequentially or otherwise, that specify actions to be taken by machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 may include processors 1110, memory 1130, and I/O components 1150, which may be configured to communicate with each other such as via a bus 1102. In an example embodiment, the processors 1110 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1112 and processor 1114 that may execute instructions 1116. The term “processor” is intended to include multi-core processor that may comprise two or more independent processors (sometimes referred to as “cores”) that may execute instructions contemporaneously. Although FIG. 11 shows multiple processors, the machine 1100 may include a single processor with a single core, a single processor with multiple cores (e.g., a multi-core process), multiple processors with a single core, multiple processors with multiples cores, or any combination thereof.

The memory/storage 1130 may include a memory 1132, such as a main memory, or other memory storage, and a storage unit 1136, both accessible to the processors 1110 such as via the bus 1102. The storage unit 1136 and memory 1132 store the instructions 1116 embodying any one or more of the methodologies or functions described herein. The instructions 1116 may also reside, completely or partially, within the memory 1132, within the storage unit 1136, within at least one of the processors 1110 (e.g., within the processor's cache memory), or any suitable combination thereof, during execution thereof by the machine 1100. Accordingly, the memory 1132, the storage unit 1136, and the memory of processors 1110 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1116. The term “machine-readable medium” shall also be taken to include any medium, or combination of multiple media, that is capable of storing instructions (e.g., instructions 1116) for execution by a machine (e.g., machine 1100), such that the instructions, when executed by one or more processors of the machine 1100 (e.g., processors 1110), cause the machine 1100 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1150 may include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion and the grouping is in no way limiting. In various example embodiments, the I/O components 1150 may include output components 1152 and input components 1154. The output components 1152 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1150 may include biometric components 1156, motion components 1158, environmental components 1160, or position components 1162 among a wide array of other components. For example, the biometric components 1156 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1162 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via coupling 1182 and coupling 1172 respectively. For example, the communication components 1164 may include a network interface component or other suitable device to interface with the network 1180. In further examples, communication components 1164 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., a peripheral device coupled via a Universal Serial Bus (USB)).

Moreover, the communication components 1164 may detect identifiers or include components operable to detect identifiers. For example, the communication components 1164 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1164, such as, location via Internet Protocol (IP) geo-location, location via Wi-Fi® signal triangulation, location via detecting a NFC beacon signal that may indicate a particular location, and so forth.

In various example embodiments, one or more portions of the network 1180 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1180 or a portion of the network 1180 may include a wireless or cellular network and the coupling 1182 may be a Code Division Multiple Access (CDMA) connection, a Global System for Mobile communications (GSM) connection, or other type of cellular or wireless coupling. In this example, the coupling 1182 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1116 may be transmitted or received over the network 1180 using a transmission medium via a network interface device (e.g., a network interface component included in the communication components 1164) and utilizing any one of a number of well-known transfer protocols (e.g., hypertext transfer protocol (HTTP)). Similarly, the instructions 1116 may be transmitted or received using a transmission medium via the coupling 1172 (e.g., a peer-to-peer coupling) to devices 1170. The term “transmission medium” shall be taken to include any intangible medium that is capable of storing, encoding, or carrying instructions 1116 for execution by the machine 1100, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving a series of bids from users participating in an auction of an item that is available for sale from an online marketplace;
determining one or more values from the series of bids and times of receipt for the series of bids;
generating, using one or more processors, a graph that depicts the series of bids as a set of points based on the determined one or more values from the series of bids and the determined times of receipt for the series of bids; and
causing display of the graph on a web page corresponding to the auction of the item, the graph selectable to receive user inputs that affect the series of bids.

2. The method of claim 1, wherein the graph includes a first axis corresponding to the one or more values from the series of bids and a second axis corresponding the times of receipt for the series of bids, and wherein the generating the graph includes positioning the set of points on the graph according to the one or more values and the times of receipt.

3. The method of claim 1, wherein the generating the graph that depicts the series of bids includes depicting the series of bids as increasing in value over time by a predetermined increment.

4. The method of claim 1, further comprising:
receiving an input that indicates a location on the graph;
determining a value associated with the input based on the indicated location on the graph;
determining that the value associated with the input is greater than the one or more values from the series of bids; and
generating a bid based on the value associated with the input.

5. The method of claim 4, wherein the generating the bid includes:
generating a further point on the graph based on the value associated with the input; and
causing display of the further point on the graph.

6. The method of claim 1, further comprising:
determining that a last bid in the series of bids is received; and
closing the auction of the item based on the determination.

7. The method of claim 6, wherein the determining that the last bid in the series of bids is received includes determining that no further bids are received for a predetermined period of time after the receiving of the last bid.

8. The method of claim 1, wherein the auction includes a collection of items, and wherein the causing the display of the graph includes causing the display of a graph for each item from the collection of items.

9. The method of claim 1, further comprising:
identifying at least one bid from the series of bids that is received from a particular user; and wherein the generating the graph includes marking the identified at least one bid as being received from the particular user.

10. The method of claim 1, further comprising:
determining a length of time during which at least a predetermined number of bids from the series of bids are received; and
calculating a value based on the predetermined number of bids that are received during the determined length of time.

11. The method of claim 10, wherein the generating the graph includes indicating the calculated value.

12. A system comprising:
a reception module configured to receive a series of bids from users participating in an auction of an item that is available for sale from an online marketplace;
a determination module configured to determine one or more values from the series of bids and times of receipt for the series of bids;
a generation module configured to generate a graph that depicts the series of bids as a set of points based on the determined one or more values from the series of bids and the determined times of receipt for the series of bids; and
a display module configured to cause display of the graph on a web page corresponding to the auction of the item, the graph selectable to receive user inputs that affect the series of bids.

13. The system of claim 12, wherein the graph includes a first axis corresponding to the one or more values from the series of bids and a second axis corresponding the times of receipt for the series of bids, and wherein the generating the graph includes positioning the set of points on the graph according to the one or more values and the times of receipt.

14. The system of claim 12, wherein the generation module is further configured to depict the series of bids as increasing in value over time by a predetermined increment.

15. The system of claim 12, wherein the reception module is further configured to receive an input that indicates a location on the graph, wherein the determination module is further configured to:
determine a value associated with the input based on the indicated location on the graph; and
determine that the value associated with the input is greater than the one or more values from the series of bids; and
wherein the generation module is further configured to generate a bid based on the value associated with the input.

16. The system of claim 15, wherein the generation module is further configured to generate a further point on the graph based on the value associated with the input, and wherein the display module is further configured to cause display of the further point on the graph.

17. The system of claim 12, further comprising:
an identification module configured to identify at least one bid from the series of bids that is received from a particular user; and wherein the generation module is further configured to mark the identified at least one bid as being received from the particular user.

18. The system of claim 12, wherein the determination module is further configured to:
determine a length of time during which at least a predetermined number of bids from the series of bids are received; and
calculate a value based on the predetermined number of bids that are received during the length of time.

19. The system of claim 18, wherein the generation module is further configured to indicate the calculated value.

20. A non-transitory machine-readable medium storing instructions that, when executed by one or more processors of a machine, cause the machine to perform operations comprising:
receiving a series of bids from users participating in an auction of an item that is available for sale from an online marketplace;
determining one or more values from the series of bids and times of receipt for the series of bids;
generating a graph that depicts the series of bids as a set of points based on the determined one or more values from the series of bids and the determined times of receipt for the series of bids; and
causing display of the graph on a web page corresponding to the auction of the item, the graph selectable to receive user inputs that affect the series of bids.
